(19) United States
(12) Patent Application Publication
(10) Pub. No.: US 2011/0228518 A1
(43) Pub. Date: Sep. 22, 2011

(54) LIQUID ILLUMINATOR AND ASSEMBLY THEREOF

(75) Inventor: Marcus Jonby Vagnby, Kobenhavn K (DK)

(73) Assignee: PULZ LIMITED, Hong Kong (HK)

(21) Appl. No.: 13/130,581

(22) PCT Filed: Apr. 6, 2009
(86) PCT No.: PCT/IB2009/051433

§ 371 Date: May 23, 2011

(30) Foreign Application Priority Data
Nov. 24, 2008 (HK) 08112830.1

(51) Int. Cl. F21V 33/00

(52) U.S. Cl. 362/101

(57) ABSTRACT

An illuminator (20) and a liquid container assembly including the illuminator are disclosed. The illuminator (20) includes a light source (24), a power source and a coupling portion (22). The coupling portion (22) is flexibly compressible such that the illuminator (20) is easily inserted and secured within a space of a suitable size provided on the surface of the liquid container. The illuminator (20) can be used in combination with various liquid container such as drinking glass or liquid bottle to provide illumination to the liquid in the container.

### TECHNICAL FIELD

### Field of Invention

This invention relates to the field of a light apparatus in general and, in particular, to an illuminating apparatus that is used to illuminate the liquid contained in a container.

### BACKGROUND ART

### Background of Invention

Of great concern to people when enjoying a drink is the mood and atmosphere which is especially important for alcoholic or other types of beverages. Producers are continuously adding decoration to the liquid bottle or drinking glass. One conventional method to add illumination is to add a base support to the container, which includes a light, and power supply.

Another approach is to put a light source in the container, like a candle, for illuminating the container. However, this method is only appropriate for an empty container and the candle cannot coexist with the liquid in the bottle.

### DISCLOSURE OF INVENTION

### Summary of Invention

It is an object of the present invention to provide a novel container illuminator.

Accordingly, the present invention, in one aspect, is a lighting apparatus including a light source, a power source electrically connected to the light source, and a coupling portion connected to the light source. The coupling portion is flexibly compressible such that the light apparatus is easily inserted and secured within a space of a suitable size provided on the surface of the container.

In another aspect of the present invention, a liquid container assembly with illuminating light is disclosed. The liquid container assembly contains a liquid container and a light apparatus. The liquid container further includes a cavity formed on at least one surface. The light apparatus contains a light source, a power source electrically connected to the light source, and a coupling portion connected to the light source. The coupling portion is flexibly compressible such that the light apparatus is easily inserted and secured within the cavity in the liquid container.

There are many advantages to the present invention, one of which is that the flexible material used in the cover of the illuminator makes it suitable to adapt to various size of the space provided. In certain specific embodiment, the illuminator is adapted for simple insertion into a specially designed cavity created in the container. It makes the illuminator very easy to install and use. Certain implementations also allow for very simple mechanical and/or electrical design such that the illuminator can be very compact. A single size of the illuminator can be used for various sizes of bottles and containers as long as the size of the cavity to which it is inserted is appropriately adapted and shall be explained in the following specific implementation examples. The following invention can be applied to but not limited to wine bottle, drinking glass or any other types of liquid container.

### BRIEF DESCRIPTION OF FIGURES

FIG. 1a is the perspective view of the illuminator in one embodiment of the present invention.

FIG. 1b is the perspective view of the illuminator in FIG. 1 from the bottom side.

FIG. 2 is an exploded view of the illuminator in one embodiment of the present invention.

FIG. 3a is a cross-sectional view of the illuminator assembly which includes a bottle according to one embodiment of the present invention.

FIG. 3b is a perspective view of the illuminator assembly in FIG. 3a.

FIG. 4a is the cross-sectional view of the illuminator and a corresponding container assembly in a disassembled state.

FIGS. 4b and 4c are perspective views of the illuminator assembly in FIG. 4a in disassembled status, which includes a liquid bottle.

FIG. 5a is a cross-sectional view of the illuminator assembly which includes a drinking glass in one embodiment of the present invention.

FIGS. 5b and 5c are perspective views of the illuminator assembly in FIG. 5a which includes a drinking glass.

FIG. 6a is the cross-sectional view of the illuminator assembly in disassembled status, which includes a drinking glass.

FIGS. 6b and 6c are perspective views of the illuminator assembly in FIG. 6a in disassembled status, which includes a drinking glass.

### DETAILED DESCRIPTION OF THE PREFERRED EMBODIMENTS

As used herein and in the claims, “comprising” means including the following elements but not excluding others.

As used herein and in the claims, “couple” or “connect” refers to mechanical coupling or connection either directly or indirectly unless otherwise stated.

As used herein and in the claims, “cylinder” refers not only refers to geometrically defined cylinder but it may also refers to similar shapes or variations, for example, a conical shape, a cone shape with a flat top, or a ribbed cylinder.

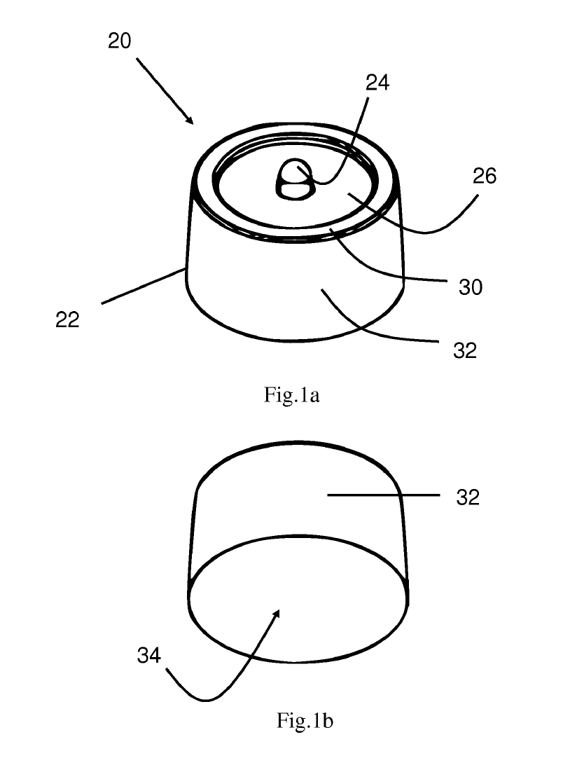

Referring now to FIGS. 1a and 1b, the first embodiment of the present invention is an illuminator 20 of a cylinder shape. The illuminator 20 includes a light source, a light cover 22, a light top 26 and a power source (not shown here). The light source is preferably a Light Emitting Diode (LED) 24. The power source is preferably a battery. The light cover 22 further includes a ring 30, a sleeve 32 and a bottom 34, all of which are formed as a single part. In this embodiment, the bottom 34 can also be referred to as the back end of the illuminator. The rings 30 together with the light top 26 constitute the front end of the illuminator. In this example, the light cover 22 and the light top 26 make up the housing of the illuminator, which covers the light source 26 and power source such that the illuminator 20 can be waterproof.

In the embodiment shown, the light cover 22 is made of flexible material and preferably silicon or rubber. The illuminator 20 further contains a switch (not shown) which is disposed within the light cover 22 at the bottom end 34.

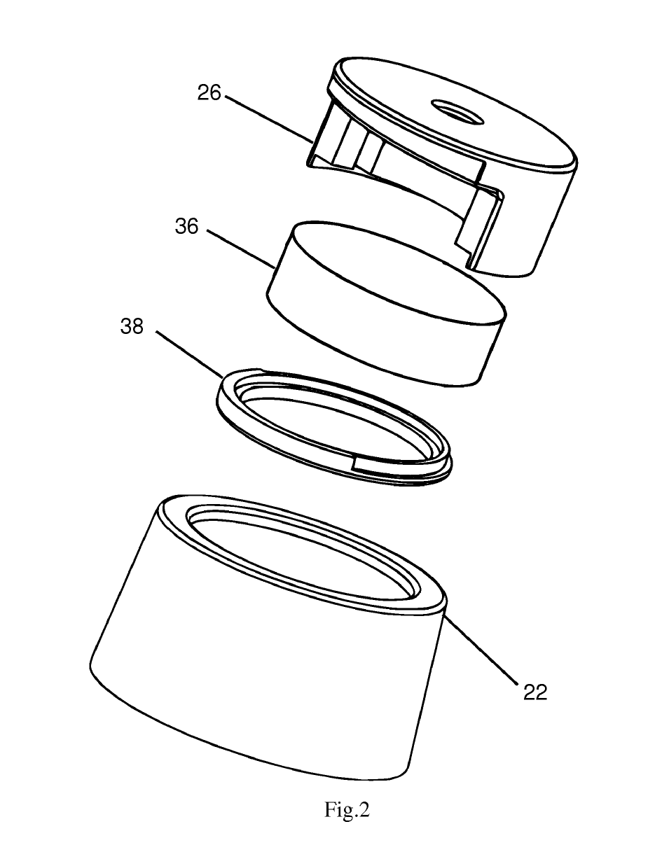

FIG. 2 shows the separate part of the light top 26, battery 36, the battery stand 38 which is a O-ring, and the light cover 22 in the same embodiment of the present invention. The light top 26 has an opening through which the head of the LED (not shown here) can be extended. The battery 36 is placed on the battery stand 38 within the light cover 22. A portion of the light top 26 also extends from the base to cover the battery 36 partially.

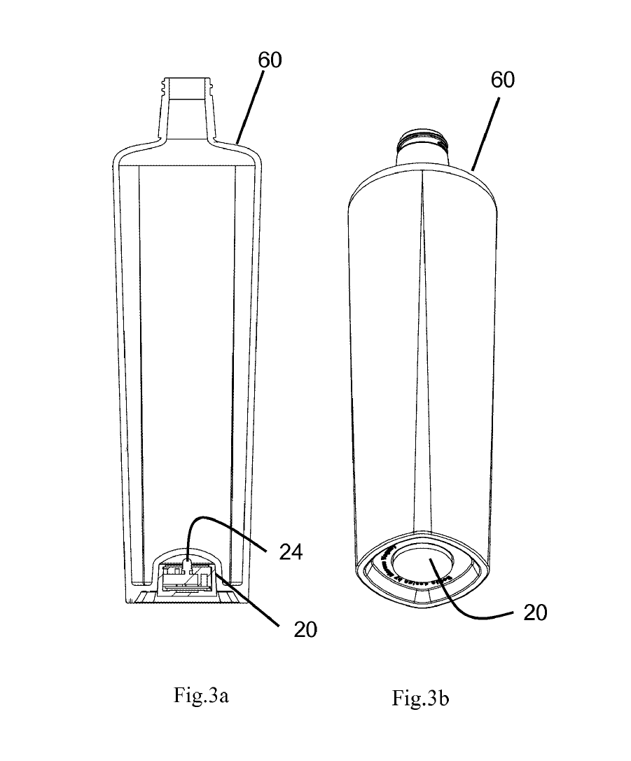

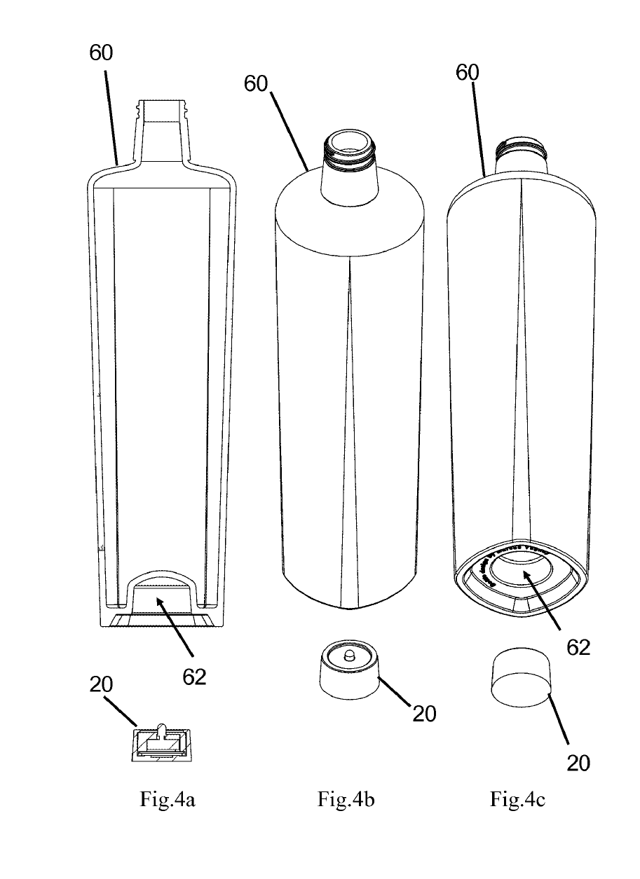

Turning now to FIG. 3a to 4c, a bottle 60 is provided with a cavity 62 at the bottom. Cavity 62 is specially designed to accommodate the illuminator 20.

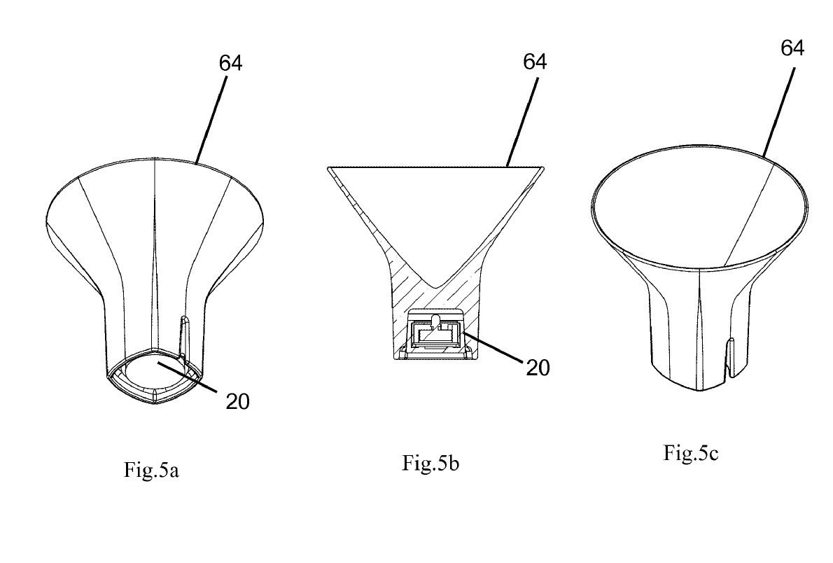

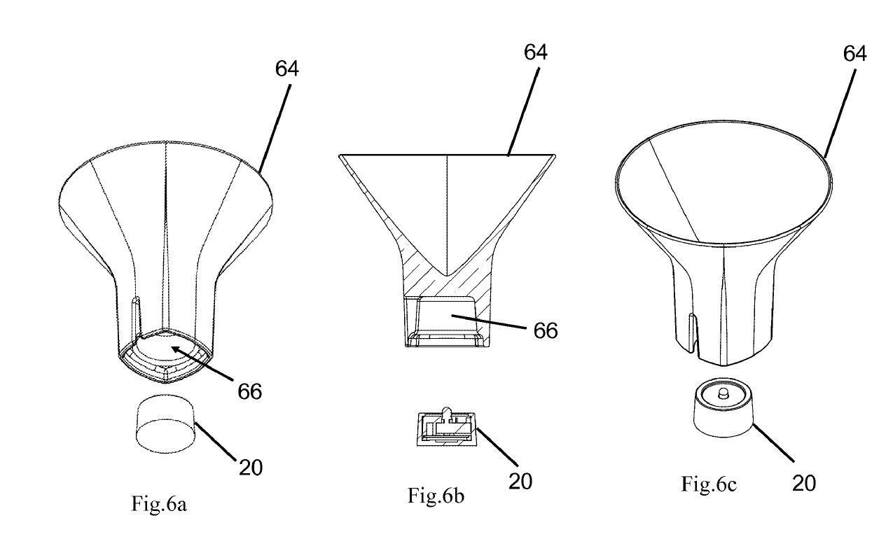

FIG. 5a to 6c is similar to the embodiment shown in FIGS. 3A to 4c, except that the type of the liquid container is changed to a drinking glass with a upside down cone shape set on a cylindrical pedestal. In this example, the cavity 66 to receive the illuminator is provided at the bottom of the pedestal.

Now turning to the operation of the device described above. When the illuminator is inserted inside the relevant cavity, the limited space of the cavity will force the rubber housing to compress, which in turn generates distention force due to the characteristics of the flexible material. The distention force will push the flexible material toward the inner surfaces of the cavity and creates frictional force therebetween. As the frictional force exists, the illuminator will not slip easily out of the cavity and its position can thus be fixed. Also, since the flexible material can be compressed to a range of elastic deformation, the illuminator is adaptable to be placed inside the cavity with a certain range of the diameter. The illuminator can be switch on/off by pressing the switch disposed within the bottom of the illuminator.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

For example, the illuminator shown in the embodiment in FIGS. 1a and 1b is using a LED 24 as the light source. In a variation, two or more LED could be provided in the same illuminator to produce different illumination effect. In another embodiment, color LED to produce colorful visual effect, including variations of flashing and colour. A microprocessor chip can also be provided within the illuminator to control the different visual effects desired by the user, including tri-colour set.

The dimensions of the inner space of the bottle cavity 62 needs not be precisely fitted for the illuminator 20. Rather, the dimension of the inner space of the bottle cavity 62 can be designed within a certain range and the illuminator would be able to be inserted therein and secured firmly due to its cover made of flexible material.

The illuminator described above contains the switch which is disposed at the bottom 34. In one implementation the switch can also be embedded in the sleeve 32, the shape of the switch can be the along the perimeter of the sleeve, such that the switch can be turned on/off wherever people presses the sleeve. For example, the user can switch on the illuminator by pressing the sleeve while the illuminator is outside the container before inserting the illuminator into the cavity.

In one variation of the present invention, the battery installed in the illuminator could be a rechargeable battery. To facilitate the recharging, the illuminator further has at least one pair of contact pins on the surface of the illuminator to connect to an external recharger. For example, there can be two contact pins disposed on the light top 26, one of which is an anode and the other one is a cathode. The illuminator can then be provided together with the appropriate recharger.

In a further variation, the illuminator is equipped with coils or loops instead of contact pins for recharging. Correspondingly, the external recharger also contains coils or loops so that the rechargeable battery in the illuminator can be recharged by inductive charging. Inductive charging could be useful for liquid illuminator as they are often exposed to water. The battery and electrical portions of the light can be completely sealed within the housing to prevent exposure to moisture.

In another implementation, the illuminator in the present invention has multiple operation modes, i.e. the LED's on and off time can be adjusted. In one implementation, the illuminator has four modes: off, always-on, slow flashing and fast flashing. As mentioned previously, the illuminator can adopt more than one LED or color LED, so that more variation of the LED illumination may be developed.

The liquid container assembly described above is exemplified by a liquid bottle and a drinking glass. However, one with ordinary skill in the art should realize that the illuminator could be used in other kind of liquid container with different shape and geometry. For example, the illuminator can be installed at the bottom of a beverage bottle, a glass jar, or a cosmetic bottle. Furthermore, different containers may be available to the end user based on the same size of illuminator and may be sold as a set.

In the exemplary embodiment described above, the illuminator is located at the bottom of the liquid container. However, in order to add more variation to the illumination effect, the illuminator can also be located at other part of the liquid container. For example, the illuminator can be located at the bottom and at a side surface of the container so that the light illuminating the liquid could come from different directions.

1. A lighting apparatus used for illuminating a container comprising:
a) a light source;
b) a power source electrically connected to said light source; and
c) a coupling portion connected to said light source for supporting said light source and said power source,
wherein said coupling portion is flexibly compressible such that said light apparatus is easily inserted and secured within a space of a suitable size provided on surface of said container, and said light source is adapted to illuminate interior of said container.

2. The lighting apparatus of claim 1 further comprises a housing; at least a portion of exterior surface of said housing forming said coupling portion wherein insertion of said lighting apparatus into said space of said container creates a distention force on said coupling portion for resilient plugging of said lighting apparatus into said container.

3. The lighting apparatus of claim 1, wherein said coupling portion forms part of a housing of said lighting apparatus, said housing formed into a shape of a plug having, a front end, a back end and a sleeve; said coupling portion disposed along said sleeve such that when said lighting apparatus is inserted into said space of said container, the restricted size of the space forms a distention force on said coupling portion for resilient plugging of said lighting apparatus to said container.

4. The lighting apparatus of claim 3, wherein said coupling portion comprises a layer of flexible material, and said front end, sleeve and back end of said housing are formed into a cylindrical shape with said light source disposed at the front end.

5. The lighting apparatus of claim 4, wherein said layer of flexible material extend along said back end to make said lighting apparatus waterproof.

6. The lighting apparatus of claim 4, wherein said flexible material is made of rubber or silicon.

7. The lighting apparatus of claim 3 further comprises a push button switch, said switch disposed at said back end or within said layer of flexible material such that said lighting apparatus can be switched on or off by pressing said back end or said sleeve of said lighting apparatus.

8. The lighting apparatus of claim 1, wherein said light source is a light emitting diode.

9. The lighting apparatus of claim 1, wherein said power source is a rechargeable battery; said light apparatus further comprising at least one contact pin for connecting to an external recharger.

10. A liquid container assembly with illuminating light comprising:
a) a liquid container, said liquid container further comprising a cavity formed on at least one surface;
b) a light apparatus, said light apparatus further comprising:
i) a light source;
ii) a power source electrically connected to said light source; and
iii) a coupling portion connected to said light source for supporting said light source and said power source,
wherein said coupling portion is flexibly compressible such that said light apparatus is easily inserted and secured within said cavity in said liquid container.

11. The liquid container assembly of claim 10, wherein said light apparatus further comprises a housing; at least a portion of the exterior surface of said housing forming said coupling portion wherein insertion of said lighting apparatus into said cavity of said liquid container creating a distention force on said coupling portion for resilient plugging of said lighting apparatus into said liquid container.

12. The liquid container assembly of claim 10, wherein said coupling portion forms part of a housing of said lighting apparatus, said housing formed into a shape of a plug having a front end, a back end and a sleeve; said coupling portion disposed along said sleeve such that when said lighting apparatus is inserted into said cavity of said liquid container, restricted size of the cavity forms a distention force on said coupling portion for resilient plugging of said lighting apparatus to said liquid container.

13. The liquid container assembly of claim 12, wherein said coupling portion comprises a layer of flexible and waterproof material, and said front end, sleeve and back end of said housing are formed into a cylindrical shape.

14. The liquid container assembly of claim 13, wherein said cavity is formed extending from the bottom of the container towards the interior of the container; said housing formed into a general shape of a hollow cylinder with said layer of flexible and waterproof material forming said housing at said sleeve and back end; said light source being disposed on the exterior surface of said front end, said power source being provided within said housing in a waterproof manner.

15. The liquid container assembly of claim 13, wherein said flexible material is made of rubber or silicon.
